(19) United States
(12) Patent Application Publication
(10) Pub. No.: US 2006/0044597 A1
(43) Pub. Date: Mar. 2, 2006

(54) Print job workflow system

(76) Inventors: Tiberiu Alexandru Dumitrescu, Simi Valley, CA (US); Margareta Vamos, Woodland Hills, CA (US); Alin Petru Irimie, Dunedin, FL (US)

Correspondence Address: SoCAL IP LAW GROUP LLP, 310 N. WESTLAKE BLVD. STE 120, WESTLAKE VILLAGE, CA, 91362, US

(21) Appl. No.: 10/932,800

(22) Filed: Sep. 1, 2004

(51) Int. Cl. G06F 15/00

(52) U.S. Cl. 358/1.15; 358/1.6

(57) ABSTRACT

There are disclosed print job workflow methods and systems. A method may comprise providing a user interface to allow a user to select one or more workflow elements and to create a current workflow. A user selection of one or more workflow elements may be received as selected workflow elements. User placement of the selected workflow elements to create the current workflow may be recognized. Information about the selected workflow elements included in the current workflow may be received. Verification of the current workflow may be performed. A system may be implemented on a computing device and may cause a print job to be printed on a printing device.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field of the Invention

The present invention relates to printers, print jobs, and control of printers and print jobs.

2. Description of the Related Art

Printers are ubiquitous in society. Printers are used in schools, at work, at home, at points of sale, and many other locations. Mass mailings may be created with printers that have features that allow them to handle jobs requiring large volumes of printed matter. Many high volume printers can be controlled by external computers. Many printers are capable of communicating with and receiving print jobs from a computer over a network.

The features and technologies included in printers has been advancing steadily. In some circumstances, when a new printer having new features is acquired, the software and/or print jobs on a controlling computer may not be capable of taking advantage of the new features of the new printer and/or the software and/or print jobs on a controlling computer may need to be upgraded or to take advantage of new features of the new printer.

### DESCRIPTION OF THE DRAWINGS

FIG. 1 is a block diagram of an environment in which the print job workflow system described herein may operate.

FIG. 2 is a flowchart of the actions taken by a print job workflow system.

FIG. 3 is a flowchart of the actions taken by a print job workflow system in design mode.

FIG. 4 is an example screen shot of a user interface provided by a print job workflow system.

FIG. 5 is another example screen shot of a user interface provided by a print job workflow system.

FIG. 6 is a flowchart of the actions taken by a print job workflow system in processing mode.

### DETAILED DESCRIPTION

Throughout this description, the embodiments and examples shown should be considered as exemplars, rather than limitations on the apparatus and methods of the present invention.

A System

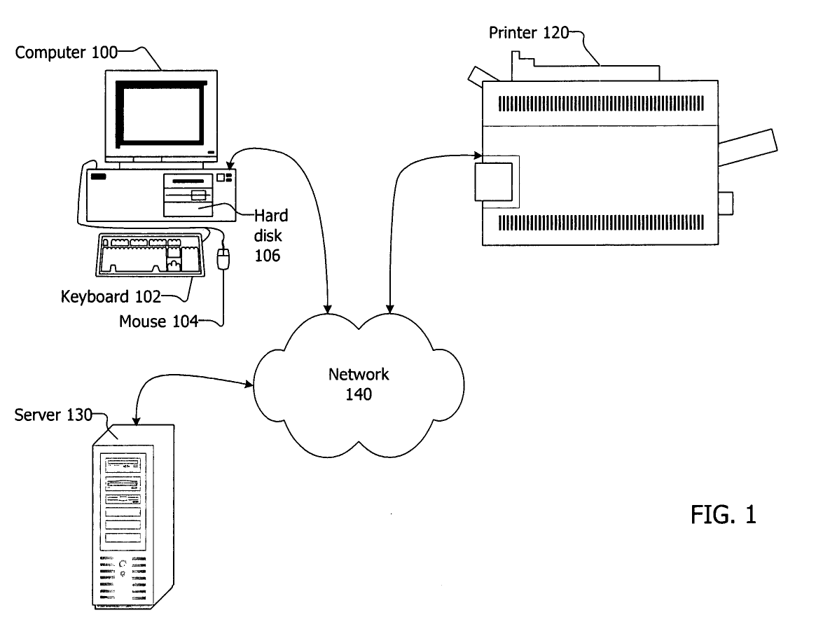

FIG. 1 is a block diagram of an environment in which the print job workflow system described herein may operate. Computer 100, printer 120 and server 130 may communicate over network 140. Although only one computer 100 and one printer 120 are shown, two or more computing devices and two or more printing devices may be coupled with network 140 and incorporated in the methods and systems described herein.

The environment shown includes computer 100 which may be a personal computer or other computing device. The print job workflow system may be implemented with any computing device. A computing device as used herein refers to any device with a processor capable of executing instructions, a communications unit, memory and at least one storage device. A computing device may be, for example, a personal computer, a server computer, a computer workstation, a computing tablet, a portable computer, and a laptop computer. These computing devices may run any operating system, including, for example, variations of the Linux, Unix, MS-DOS, Microsoft Windows, and Apple Mac OS operating systems.

Computer 100 may include a hard disk 106 and/or other storage device, and may have user input devices such as, for example, keyboard 102 and mouse 104 coupled thereto. Other user input devices such as, for example, track balls and others may be included in addition to and in place of the keyboard 102 and mouse 104.

Although shown as a hard disk 106, the personal computer may include other storage devices in addition to or in place of hard disk 106. As used herein, a storage device is a device that allows for the reading from and/or writing to a machine readable medium. A storage device may include or be a machine readable medium. A machine readable medium is a medium that includes code, data, instructions or other information which can be read by and/or executed by a processor. A machine readable medium includes, for example, magnetic media (e.g., hard disks, tape, floppy disks), optical media (e.g., compact disk (CD) and digital versatile disk (DVD)), flash memory products (e.g., memory stick, compact flash and others), and volatile and non-volatile silicon memory products (e.g., flash memory, random access memory (RAM), programmable read-only memory (PROM), electronically erasable programmable read-only memory (EEPROM), and others). Example storage devices include hard disk drives, CD drives, DVD drives, flash memory devices, and others.

The print job workflow system may be embodied in software such as one or more of an application program, applets (e.g., a Java applet), a browser plug-in, a COM object, a dynamic linked library (DLL), a script, subroutines, an operating system component or service, or a combination of these and other software components. In one embodiment, the print job workflow system is implemented as application program software stored on hard disk 106 and/or other storage device included in or coupled with computer 100. In this embodiment, the application software may include or access plug-ins or other software components from an external source such as, for example, server 130 or another computing device on network 140.

The personal computer 100 includes at least one communications unit. The communications unit may be a network interface card (NIC) or other device that allows the personal computer 100 to access other computing devices and/or network capable devices over a network 140, including, for example, server 130 and printer 120. A network capable device is any device that is capable of communicating over a network 140. Network 140 may be a local area network (LAN), a wide area network (WAN), the Internet, a public network, a private network, other network, and a combination thereof. The network 140 may be wired, wireless, or a combination thereof. The network 140 may include or be the Internet and may support Ethernet, the transmission control protocol/internet protocol (TCP/IP), and other communications protocols.

The computer 100 may be directly connected (not shown) to printer 120. In this embodiment, the communications between the computer 100 and the printer may be via a wired connection or a wireless connection, and may be achieved according to a proprietary scheme or a communications standard, such as, for example, Universal Serial Bus (USB), IEEE 1394 (also known as Firewire and i.link), Ethernet, IEEE 802.11 (also known as Wi-Fi), ZigBee, Bluetooth, and others. As such, a communications unit may be a chip or chipset that provides support for one or more wired and/or wireless communications standards.

Printer 120 may be any device capable of printing on paper or other media, and may be referred to as a printing device. Printer 120 may be network capable and may include a communications unit as described above. In addition, printer 120 may have many or all of the features of a computing device such as, for example, a processor, memory, and one or more storage devices.

Methods

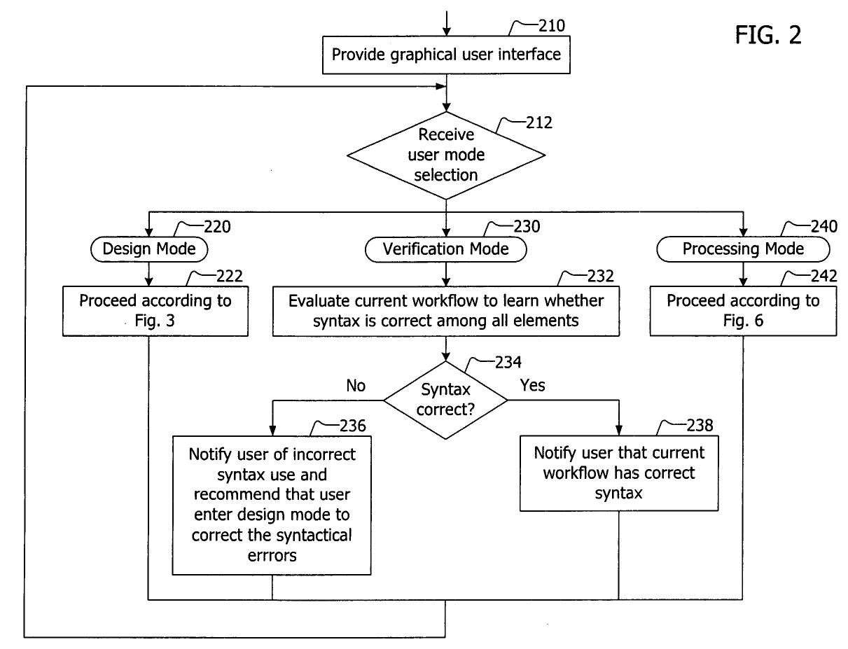

FIG. 2 is a flowchart of the actions taken by a print job workflow system. The print job workflow system may execute a method implemented as software such as, for example, an application program that may be supplemented with one or more plug-in modules that add various features to the print job workflow system. The print job workflow system may allow a user to specify, execute and/or verify a workflow. A workflow defines one or more input information sources, processing to be performed on input information received from the one or more information sources, and one or more output destinations to which output information resulting from the processing is directed. As used herein, the input information sources are referred to as input elements, the processing is performed by processing elements, and the output destinations are referred to as output elements. Each of these elements is referred to as a workflow element. A workflow as used herein refers to an arrangement of workflow elements in which one or more input elements provide input information to one or more processing elements which provide output to one or more output elements. Example input elements, processing elements and output elements are described in more detail below.

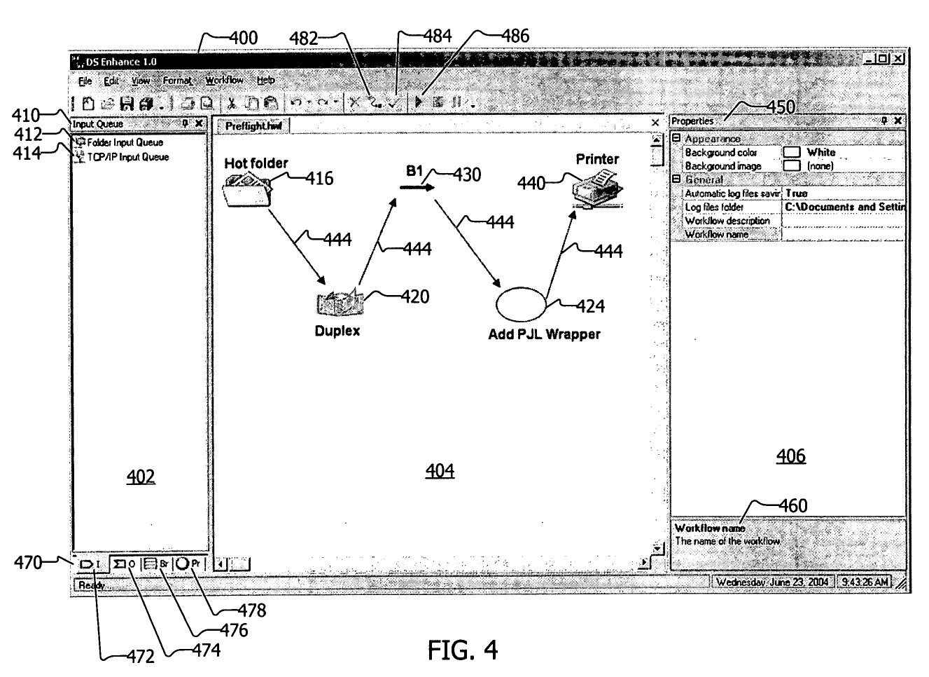

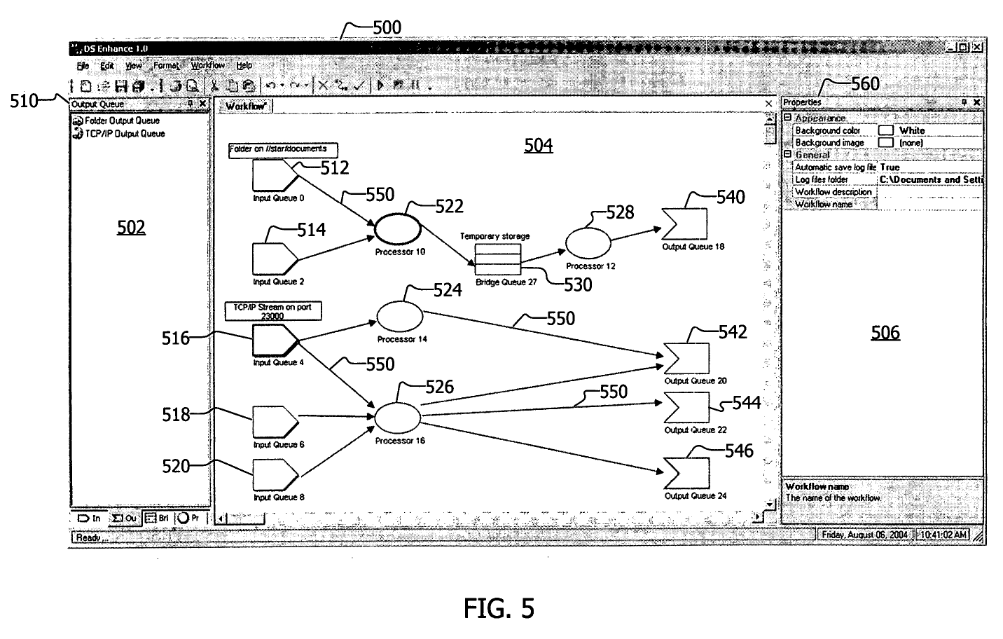

The workflow elements may be arranged to form a workflow. Each of the workflow elements may be graphically represented by a drawing, icon, graphical image or other rendering. Connectors may be used to link the workflow elements into a workflow. The connectors may be implemented graphically as lines representing the flow of information between workflow elements. This is shown in and described below regarding FIGS. 4 and 5. Each of the workflow elements may be arranged in a sequence beginning with an input element and ending with an output element. The workflow may proceed from element to element along the connectors. The workflow may be arranged from left to right, right to left, diagonally, circularly, and in any arrangement desired by a user. There may be one or more input elements at the beginning of a workflow, and some input elements may be located after some processing elements. In addition, a workflow may have multiple destination output elements. As such, a workflow may allow for non-linear arrangement of workflow elements.

The print job workflow system may provide a graphical user interface, as shown in block 210. The print job workflow system may create a user interface using windows, panes, style sheets, frames, forms, and/or other constructs made available by the operating system, desktop metaphor software, and/or provided by the print job workflow system. Various user interface items may be included in the windows, panes or other user interface constructs. The user interface items may include menus (pull-down, walking, and others), tabs, check boxes, selection circles, text, graphics, icons, sliders, knobs, button, and other items. Example graphical user interfaces of a print job workflow system are shown in and described below regarding FIGS. 4 and 5.

The graphical user interface may allow a user to select between two or more modes of the print job workflow system. The modes may include design mode, verification mode and processing mode. In various embodiments, the modes may be presented to a user as tabs of panes, as buttons, as icons, in menus, and other user interface item or construct. The print job workflow system may receive a user mode selection, as shown in block 212.

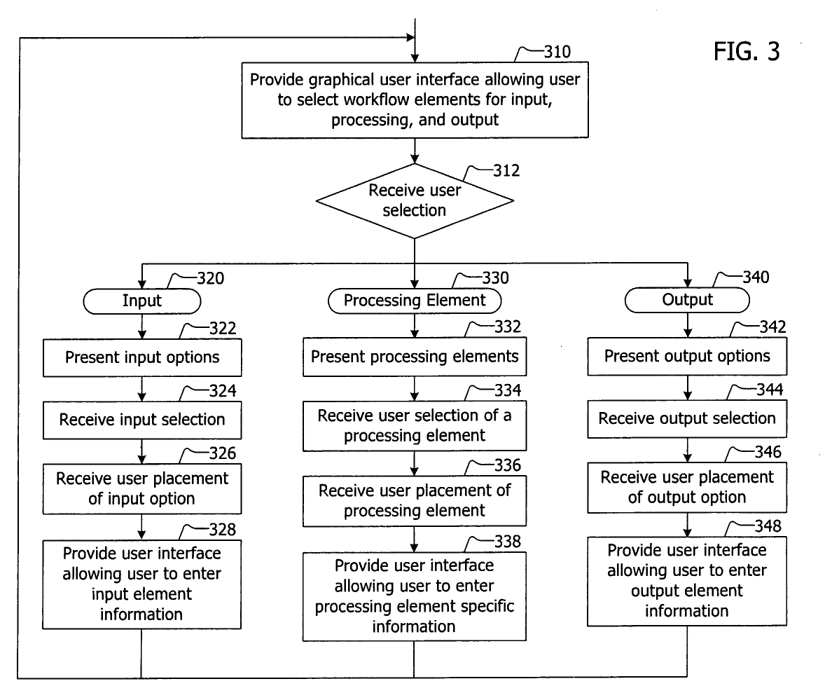

When the user selects design mode, as shown in block 220, the flow of actions continues as discussed below regarding FIG. 3, as shown in block 222.

When the user selects verification mode, as shown in block 230, the print job workflow system evaluates the current workflow to learn whether the syntax is correct among all processing elements. For example, for those processing elements requiring certain kinds of input, the inputs to those processing elements are checked to ensure that they correspond to the input required by the particular processing elements. If the syntax of the workflow is not correct, the print job workflow system notifies the user that incorrect syntax is used in the workflow and may recommend that the user enter design mode to correct the syntactical errors, as shown in block 236. The user may be notified of errors by visual cues such as color change of problem areas in the workflow, flashing of problem areas in the workflow, or by otherwise making the problem areas in the workflow conspicuous to a user. An audible alert may also be issued. The audible alert may, for example, be synthesized or actual recorded human voice, music, sound effect or other sound. If the syntax of the workflow is correct, the print job workflow system may notify the user that the syntax is the current workflow is correct, as shown in block 238. This may be achieved by displaying a text message and/or by displaying a graphical image such as, for example, a big check mark. An audible alert may also be issued.

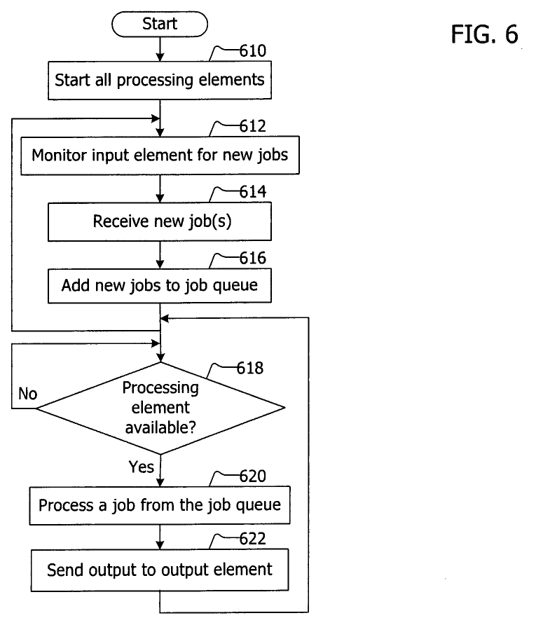

When the user selects processing mode, as shown in block 240, the flow of actions continues as discussed below regarding FIG. 6, as shown in block 242.

The flow of actions after blocks 222, 236, 238 and 242 continues back to block 212.

FIG. 3 is a flowchart of the actions taken by a print job workflow system in design mode. After a user selects design mode, the print job workflow system provides a graphical user interface allowing the user to select workflow elements for input, processing, and output, as shown in block 310. Design mode allows a user to construct a workflow. A workflow may be comprised of user selections of one or more of each of input elements, processing elements and output elements. In one embodiment, bridge elements may also be provided for inclusion in workflows. Workflow elements may be plug-ins in the form of, for example, DLLs or JavaScript. The workflow element plug-ins may be located in a file system folder created by the print job workflow system on a storage device. In one embodiment, there is one plug-in corresponding to each kind of workflow element.

The print job workflow system receives a user selection of a workflow element, as shown in block 312. In one embodiment, workflow elements are presented as tabbed panes. When a tab on a window pane is selected, the available elements for the type of element selected are presented in the pane. In this embodiment, a user may click on or otherwise choose an element and drag it to a current workflow window. In another embodiment, pull-down menus are provided for each of the workflow elements. In this embodiment, each workflow element submenu displays the specific elements for each of the kinds of workflow elements. In this embodiment, an element may be chosen by selecting the element from the submenu and dragged to the current workflow window. Other graphical user interface techniques may also be employed to present the workflow elements.

When the user selects input elements, as shown in block 320, the print job workflow system presents one or more input options to the user, as shown in block 322. In one embodiment, the input elements from which a user may choose are a folder input queue and a network input queue. The network input queue may be a TCP/IP input queue that monitors a TCP/IP port for incoming information or a TWAIN input queue listening to a TWAIN device. TWAIN devices include, for example, scanners and other devices. The format of an input job or data stream may be in a proprietary or well known page description language. Example input job well known formats include Printer Control Language (PCL), Printer Job Language (PJL), PostScript, Hewlett-Packard Graphics Language (HPGL) and Intelligent Printer Data Stream (IPDS), Graphical Device Interface (GDI), Portable Document Format (PDF), and others. An input job may also include or be one or more Joint Photographic Experts Group (JPEG) files, Tagged Image File Format (TIFF) files, and other files. An input job may also be a text file encoded as ASCII, EBCDIC or any other standard or proprietary character encoding.

The print job workflow system receives an input option selection from a user, as shown in block 324. The print job workflow system may receive user placement of the input option into the current workflow window, as shown in block 326. That is, the user drags and drops the input element into a desired location in the current workflow window. In one embodiment, when the user places the input option into the current workflow window, the print job workflow system automatically provides a user interface that allows the user to provide needed information about the input element, as shown in block 328. Such needed information may include a TCP/IP port designation. The user may also at the user's initiative select and edit the properties of the input element when in design mode.

When the user selects processing elements, as shown in block 330, the print job workflow system presents one or more processing elements to the user, as shown in block 332. The number of processing elements supported may vary. Processing elements may be added to support new features of a destination printer, new demands of a print job workflow system user, and the characteristics of input print jobs. Example processing elements include: a command addition processing element, a command line utility processing element, a character set conversion processing element, a data replacement processing element, a file copy processing element, a job concatenation processing element, and a job splitting processing element. Some or all of these may be provided in a print job workflow system, and additional processing elements may be included in addition to or in place of these example processing elements.

A command addition processing element allows a user to add a command to an existing print job. That is, an existing command may be edited or a new command may be inserted. For example, a command addition processing element may be defined by a user to print a job in duplex. Adding a duplex command is particularly useful if a print job designed for an older printer that does not support duplexing is to be directed to a newer printer that supports duplexing. The duplex specified command addition processing element will edit the print job so that the print job will be printed in duplex rather than simplex. This may be achieved by changing a bit or by changing and/or adding a byte/character sequence. In other circumstances an entire print job language (PJL) header may be stripped and replaced with a new header according to the command and features specified by a user for the command addition processing element.

A command line utility processing element allows a user to supply an executable file that will perform a desired task. The command line utility processing element may be used to convert a print job or a component thereof from a first format to a second format. This processing element may allow for the use of an older style executable or command script to be executed. This processing element may reduce costs as a new script in a current printer control language need not be written. The command line utility processing element may provide legacy support by interpreting or executing an old, existing script. The command line utility processing element may execute a third party program to convert features of graphics or images, to manipulate a particular file such as, for example, a PDF file, and to achieve other tasks, such as, for example, format conversion. Format conversion includes, for example, converting from PDF to PostScript, from TIFF to PCL, from JPEG to TIFF, from GIF to TIFF, from RGB (red, green blue) to CMYK, (cyan-magenta-yellow-black), and others.

A character set conversion processing element allows a user to convert from a first character set to a second character set. For example, a print job may have been created by an IBM computer that stored a job that used the Extended Binary Coded Decimal Interchange Code (EBCDIC) character set. To run the job on a new printer that supports the American Standard Code for Information Interchange (ASCII) character set, this processing element will convert a print job from EBCDIC to ASCII. Other character set conversions may also be written as plug-ins to the print job workflow system to provide support for other character set conversions.

A data replacement processing element allows a user to replace one group of data with another group of data. This may allow a user to change a name, address, time, date, commands or other information. The searched for and replacement data may be specified by a user. The data may be entered as regular text and/or by ASCII code, or other character encoding scheme.

A file copy processing element allows a user to move a file from a first location to a second location. The first and second locations may be local and/or remote to the computing device executing the print job workflow software. The user may specify the file locations.

A job concatenation processing element allows a user to concatenate two or more jobs or data streams into one. By using this processing element, efficiency is increased as down time and/or restart time incurred between jobs is removed. The user may concatenate specified jobs, and/or the print job workflow system may automatically recommend which jobs should be concatenated.

A job splitting processing element allows a user split one job into multiple jobs. A job exceeding a certain user or system specified page length or size may be broken up into two or more sequential jobs. Size may refer to the memory used by a print job or the number of lines in a print job. In one embodiment, the maximum length or size of a job may be based on the capabilities of a destination printer. For example, a hard drive or memory size of a printer may limit the length or size of a job. In various embodiments, a user may specify the length or size limit of a job, or the job splitting processing element may recommend a job length or size limit based on a printer specified as part of the workflow.

A job distribution element may be provided to automatically split jobs into multiple jobs and distribute them according to characteristics of available destination devices, such as, for example, printers. In one example job distribution element, print jobs may be split and distributed according to whether a page includes color or black and white elements. In this way, color pages of a print job may be sent to a printer that efficiently handles color printing while black and white pages or jobs are sent to a printer that efficiently handles black and white printing.

Referring again to FIG. 3, the print job workflow system receives a user selection of a processing element from a user, as shown in block 334. The print job workflow system may receive user placement of the processing element into the current workflow window, as shown in block 336. That is, the user drags and drops the processing element into a desired location in the current workflow window. When the user places the processing element into the current workflow window, the print job workflow system may provide a user interface allowing the user to enter processing element specific information, as shown in block 338. The required processing element specific information varies among the different processing elements. The user may also at the user's initiative select and edit the properties of the processing element when in design mode.

When the user selects output elements, as shown in block 340, the print job workflow system presents one or more output options to the user, as shown in block 342. In one embodiment, the output elements from which a user may choose are a folder output queue and a network output queue. The network output queue may be, for example, a TCP/IP output queue that sends outgoing information through a specified TCP/IP port. Output may be sent to a printer via a network output queue such as a TCP/IP output queue. Other output queues are also possible. The print job workflow system receives an output option selection from a user, as shown in block 344. The print job workflow system may receive user placement of the output option into the current workflow window, as shown in block 346. That is, the user drags and drops the output option into a desired location in the current workflow window. In one embodiment, when the user places the output element into the current workflow window, the print job workflow system automatically provides a user interface that allows the user to provide needed information about the output element, as shown in block 348. Such needed information may include a TCP/IP port designation of a network output queue or a folder location of a folder output queue. The user may at the user's initiative select and edit the properties of the output element when in design mode.

In another embodiment, the user may also select a bridge element to be placed between processing elements. The bridge element may be used to transfer information between processing elements. The bridge element may be a queue that can receive and send data in any of various formats, so long as the data sent between the processing elements can be processed by each of the processing elements. Bridge elements may support data transfer via a file supported by the operating system. The file may be stored on a hard drive or other storage device, and may be available to another application program or other software entity. Bridge elements may support data transfer via a stream supported by the operating system. Streams do not permanently store data on a hard drive or other storage device. Bridge elements may support data transfer via proprietary data format so long as the processing elements know what the internal structure of the data is or that they do not care.

The flow of actions after blocks 326, 338 and 346 returns to block 310.

In this way, the user may construct a workflow from the elements provided by the graphical user interface of the print job workflow system when in design mode.

FIG. 4 is an example screen shot of a user interface provided by a print job workflow system. In this example screenshot, a main window 400 is broken into three areas or sub-windows. A first sub-window 402 displays all available workflow elements to a user, a second sub-window 404 displays the current workflow, and a third sub-window 406 displays the properties of a currently selected element from the current workflow.

In first sub-window 402, four tabbed panes are provided, one each for each of the four kinds of workflow elements supported in this embodiment. Other embodiments may support more or fewer workflow elements. Sub-window 402 includes tabs 470, which when selected display all of the particular kind of workflow element. In this example, tabs 470 include tabbed pane 472 which displays input elements, tabbed pane 474 which displays processing elements, tabbed pane 476 which displays bridge elements, and tabbed pane 478 which displays output elements. The name of the selected workflow element tabbed pane may be displayed as text 410. Each kind of processing element may have a corresponding icon or graphical representation associated with it. In one embodiment, the icons associated either with a particular kind of processing element, or a specific processing element may be user customizable or selectable.

In the example shown, input element tabbed pane 472 displays two available input elements, folder input queue 412 and TCP/IP input queue 414. A specific instance of a folder input queue 412 is shown in the current workflow sub-window 404 as “hot folder” 416.

The second sub-window 404 displays the current workflow. If in design mode, a user may drag and drop workflow elements from the tabbed sub-panes of first sub-window 402 into sub-window 404 to create a workflow. The sample workflow shown in sub-window 404 begins with an input element, hot folder 416. The hot folder may be a shared folder that may receive a print job from a local program or an external source such as remotely network connected computing device. The hot folder 416 is connected with connector 444 to duplex processing element 420. When a print job is received in the hot folder, the duplex processing element 420 performs an action on the print job. In the embodiment shown, a bridge queue B1 430 is placed between duplex processing element 420 and “add PJL wrapper” processing element 424. The duplex processing element 420 is connected with connector 444 to add PJL wrapper” processing element 424. When “add PJL wrapper” processing element 424 finishes processing a particular print job, its output is directed to an output element, in the example, printer 440 through connector 444.

Although not shown in this example, a workflow may have multiple input elements and multiple output elements. This allows for the receipt and processing of multiple print jobs to multiple printers and/or other output devices.

The third sub-window 406 displays the properties of and allows a user to edit the properties of a selected element from the current workflow, or general workflow properties if no element is selected. In this example, the properties 450 are general workflow properties for the appearance and general characteristics of the current workflow. The name of the current workflow may be listed in the third sub-window as text 460.

In addition to the three sub-windows described above, in window 400, the user may select from buttons to enter a particular mode of the print job workflow system. This example allows for three modes which may be entered or started by selecting or otherwise activating an appropriate button. A design mode button 482 is provided to allow a user to enter into design mode to create, or edit a workflow. A verification mode button 484 is provided to allow a user to verify that a current workflow or specified workflow is syntactically correct and will execute without error. A start button 486 is provided to allow a user to enter processing mode and run a current or specified workflow. Although buttons are shown, other activatable graphical user interface items may be used.

FIG. 5 is another example screen shot of a user interface provided by a print job workflow system. The window 500 is similar to window 400 described above, having three sub-windows: workflow element sub-window 502, a current workflow sub-window 504, and properties sub-window 506. As shown, the output element tabbed sub-window 510 is selected in the workflow element sub-window 502. However, the workflow shown has multiple input elements and multiple output elements, and uses representations for the elements different from those shown in FIG. 4. In this example workflow, input elements 512 and 514 provide print jobs to processing element 522 via connectors 550, input element 516 provides input to processing element 524 via connectors 550, and input elements 516, 518 and 520 provide input to processing element 526 via connectors 550.

The result of the processing performed by processing element 522 is stored in a bridge queue 530 which serves as temporary storage. From bridge queue 530, the print job is passed via a connector to processing element 528. When processing element has completed its processing, the print job is sent to output element 540.

Output element 542 receives the results of processing element 524 and 526. Output elements 544 and 546 both receive the result of processing element 526 via connectors 550.

The properties sub-window 506 may show the properties 560 for a currently selected element of the workflow or general properties for the workflow or display thereof.

FIG. 6 is a flowchart of the actions taken by a print job workflow system in processing mode. When a user selects processing mode in the graphical user interface provided by the print job workflow system, all processing elements are started, as shown in block 610. Input elements are monitored for new job, as shown in block 612 This may be achieved by monitoring one or more specified input queues. As described above, The input queues may be, in one embodiment, folder input queues and network input queues. When new jobs are received, as shown in block 614, they may be added to an internal job queue, as shown in block 616. A check is then made to evaluate whether a processing element associated with the input element is available, as shown in block 618. If a processing element is not available, the job may wait a system defined period of time and check again, as shown in block 618. While waiting for a processing element, job data may be stored in a temporary location, such as, for example, a storage device. When a processing element is or becomes available, a job from the job queue is processed, as shown in block 620. Output from a processing element is directed to one or more specified output elements, as shown in block 622. The output elements may be files, printers, or other output elements.

With regard to FIGS. 2, 3 and 6, additional and fewer steps may be taken, and the steps as shown may be combined or further refined to achieve the methods described herein.

Although exemplary embodiments of the present invention have been shown and described, it will be apparent to those having ordinary skill in the art that a number of changes, modifications, or alterations to the invention as described herein may be made, none of which depart from the spirit of the invention. All such changes, modifications and alterations should therefore be seen as within the scope of the invention.

It is claimed:

1. A method comprising:
providing a user interface to allow a user to select one or more workflow elements, to create a current workflow
receiving a user selection of one or more workflow elements as selected workflow elements
recognizing user placement of the selected workflow elements in a current workflow
receiving information about the selected workflow elements included in the current workflow.

2. The method of claim 1 further comprising:
verifying the current workflow.

3. The method of claim 1 wherein the workflow elements include input elements, processing elements, and output elements.

4. The method of claim 3 wherein the workflow elements further include bridge elements.

5. The method of claim 3 wherein the input elements include one or more from the group consisting of folder input queues and network input queues.

6. The method of claim 3 wherein the output elements include one or more from the group consisting of network output queues and folder output queues.

7. The method of claim 3 wherein the processing elements include one or more from the group consisting of a command addition processing element, a command line utility processing element, a character set conversion processing element, a data replacement processing element, a file copy processing element, a job concatenation processing element, and a job splitting processing element.

8. A method comprising:
providing a user interface including a workflow element selection area, a current workflow area, and a control area
receiving a user selection of one or more selected workflow elements from the workflow element selection area
recognizing user placement of the selected workflow elements in a current workflow in the current workflow area
receiving information about the workflow elements included in the current workflow.

9. The method of claim 8 wherein the control area allows a user to select between a design mode, a verification mode and an execution mode.

10. The method of claim 8 further comprising:
receiving user selection of a mode from the control area.

11. The method of claim 8 further comprising:
verifying the current workflow.

12. The method of claim 10 wherein the mode comprises a design mode, a verification mode and an execution mode.

13. The method of claim 8 wherein the workflow element selection area includes an input element pane displaying one or more input elements, a processing element pane displaying one or more processing elements, and an output element pane displaying one or more output elements.

14. The method of claim 13 wherein the workflow element selection area further includes a bridge element pane displaying one or more bridge elements.

15. The method of claim 13 wherein the input elements include one or more from the group consisting of folder input queues and network input queues.

16. The method of claim 13 wherein the output elements include one or more from the group consisting of network output queues and folder output queues.

17. The method of claim 13 wherein the processing elements include one or more from the group consisting of a command addition processing element, a command line utility processing element, a character set conversion processing element, a data replacement processing element, a file copy processing element, a job concatenation processing element, and a job splitting processing element.

18. A machine readable medium having instructions stored thereon which when executed cause a system to perform actions comprising:
providing a user interface to allow a user to select one or more workflow elements and to create a current workflow
receiving a user selection of one or more workflow elements as selected workflow elements
recognizing user placement of the selected workflow elements to create the current workflow
receiving information about the selected workflow elements included in the current workflow.

19. The machine readable medium of claim 18 having further instructions stored thereon which when executed cause the system to perform actions comprising:
verifying the current workflow.

20. The machine readable medium of claim 18 wherein the workflow elements include input elements, processing elements, and output elements.

21. The machine readable medium of claim 20 wherein the workflow elements further include bridge elements.

22. The machine readable medium of claim 20 wherein the input elements include one or more from the group consisting of folder input queues and network input queues.

23. The machine readable medium of claim 20 wherein the output elements include one or more from the group consisting of network output queues and folder output queues.

24. The machine readable medium of claim 20 wherein the processing elements include one or more from the group consisting of a command addition processing element, a command line utility processing element, a character set conversion processing element, a data replacement processing element, a file copy processing element, a job concatenation processing element, and a job splitting processing element.

25. A system comprising a printing device and a computing device, the computing device and the printing device coupled with one another for communication, the computing device having a processor, a memory and a storage device, the storage device having instructions stored thereon which when executed cause a system to perform actions comprising:
providing a user interface to allow a user to select one or more workflow elements and to create a current workflow
receiving a user selection of one or more workflow elements as selected workflow elements
recognizing user placement of the selected workflow elements to create the current workflow
receiving information about the selected workflow elements included in the current workflow
executing the current workflow causing a print job to be printed on the printing device.

26. The system of claim 25 wherein the storage device has further instructions stored thereon which cause the system to perform further operations including:
verifying the current workflow.

27. The system of claim 25 wherein the workflow elements include input elements, processing elements, and output elements.

28. The system of claim 27 wherein the workflow elements further include bridge elements.

29. The system of claim 27 wherein the input elements include one or more from the group consisting of network input queues and folder input queues.

30. The system of claim 27 wherein the output elements include one or more from the group consisting of network output queues and folder output queues.

31. The system of claim 27 wherein the processing elements include one or more from the group consisting of a command addition processing element, a command line utility processing element, a character set conversion processing element, a data replacement processing element, a file copy processing element, a job concatenation processing element, and a job splitting processing element.

32. A system comprising at least one computing device, the computing device having at least one processor, a memory and at least one storage device, the storage device having instructions stored thereon which when executed cause a system to perform actions comprising:
providing a user interface to allow a user to select one or more workflow elements and to create a current workflow
receiving a user selection of one or more workflow elements as selected workflow elements
recognizing user placement of the selected workflow elements to create the current workflow
receiving information about the selected workflow elements included in the current workflow
executing the current workflow, the executing causing a print job to be one or more of
stored on the computing device,
communicated from a first computing device to a second computing device, and/or
printed on one or more printing devices.

33. The system of claim 32 wherein the storage device has further instructions stored thereon which cause the system to perform further operations including:
verifying the current workflow.

34. The system of claim 32 wherein the workflow elements include input elements, processing elements, and output elements.

35. The system of claim 34 wherein the workflow elements further include bridge elements.

36. The system of claim 34 wherein the input elements include one or more from the group consisting of network input queues and folder input queues.

37. The system of claim 34 wherein the output elements include one or more from the group consisting of network output queues and folder output queues.

38. The system of claim 34 wherein the processing elements include one or more from the group consisting of a command addition processing element, a command line utility processing element, a character set conversion processing element, a data replacement processing element, a file copy processing element, a job concatenation processing element, and a job splitting processing element.
